(19) United States
(12) Patent Application Publication
(10) Pub. No.: US 2019/0362218 A1
(43) Pub. Date: Nov. 28, 2019

(54) ALWAYS LISTENING AND ACTIVE VOICE ASSISTANT AND VEHICLE OPERATION

(71) Applicant: FORD GLOBAL TECHNOLOGIES, LLC, Dearborn, MI (US)

(72) Inventor: Sandeep Raj GANDIGA, Santa Clara, CA (US)

(21) Appl. No.: 15/987,183

(22) Filed: May 23, 2018

(51) Int. Cl. G06N 3/00; G06N 99/00; G10L 15/22; G10L 15/18; G06F 17/27

(52) U.S. Cl. CPC G06N 3/006; G06N 99/005; G10L 15/22; G10L 15/30; G06F 17/271; G10L 2015/223; G10L 2015/228; G10L 15/1815

(57) ABSTRACT

A vehicle includes an interface. The vehicle includes a controller configured to select topics for generating an answer to a question based on an operating parameter of a vehicle, and operate the interface to output the answer to an occupant. The selection being responsive to input originating from verbal utterances of the occupant, and defining a plurality of different topics and ending with a question.

### TECHNICAL FIELD

This disclosure relates to the operation of vehicles through active and always listening voice assistance.

### BACKGROUND

Query systems give answers to questions asked after an invocation. For example, an invocation may be included at the beginning of a phrase such as “Hey Ford®, what is the weather like today?” After the invocation, “Hey Ford®,” natural language processing and artificial methods are used to find an answer to the question. This cadence, where invocation is required prior to the question, may require more statements than necessary to provide the answer because conversations prior to invocation are ignored.

### SUMMARY

A vehicle includes an interface. The vehicle includes a controller configured to select topics for generating an answer to a question based on an operating parameter of a vehicle, and operate the interface to output the answer to an occupant. The selection being responsive to input originating from verbal utterances of the occupant, and defining a plurality of different topics and ending with a question.

A method by a controller includes selecting a topic for generating an answer to a question based on an operating parameter of a vehicle responsive to input originating from verbal utterances of an occupant, and defining a plurality of different topics and ending with a question. The method further includes operating an interface to output the answer to the occupant.

A vehicle includes a controller configured to isolate a topic from a set of topics within the verbal utterances based on an operating parameter of the vehicle and operate the vehicle according to an answer of associated with the topic relative to the tag question phrase provided by an answering algorithm. The isolation is responsive to receiving verbal utterances including a tag question phrase.

### BRIEF DESCRIPTION OF THE DRAWINGS

FIG. 1 is a schematic of a vehicle having an infotainment system and associated communications capabilities;

FIG. 2 is a schematic of vehicle control systems and peripherals;

FIG. 3A is an algorithm always listening voice systems; and

FIG. 3B is an algorithm for selecting contexts.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Vehicle occupants carry on conversations discussing events, circumstances, or issues of the past, present, and future. Instead of using a regimented cadence such as, “Hey Ford®, what is the temperature outside,” requiring a forward-biased invocation, a reverse cadence may be used. Questions using a reverse cadence may include a tag question or a tag question phrase, and the processing software may always be listening. As the topics of potential questions are organized, the algorithm waits for an invocation such as, “Ford®, what do you think?” A tag question is an interrogative that follows a statement as opposed to preceding a statement. A tag question phrase may include a moniker of whom the question is being asked. The always listening and tag question answering service provides a reverse cadence where the statement is made, the service is invocated, and then the answer is provided. The always listening service may also always search for answers to every topic so that the answer is readily available for presentation to the occupant.

An inherent problem with a reverse cadence is that a conversation may include multiple answerable topics, and the occupants desired answer topic is not particularly clear. An example conversation is provided below:
Suzy says, “The Detroit Symphony Orchestra is playing tonight in Detroit.”
John says, “I bet we have enough fuel to get to Detroit but it is going to be very cold.” “Ford®, what do you think?”

The previous conversation included at least three topics 1) the Detroit Symphony Orchestra is playing tonight in Detroit; 2) I bet we have enough fuel to get to Detroit; and 3) it is going to be very cold. The topics may be isolated based on syntactical, categorical, or other methods. Over time, the topics may be distilled and isolated to particular contexts. The contexts may be broad categories of topics of which answers may be required. The contexts may also be presented to vehicle occupants for selection. The selection may also be provided via machine learning such that topics are selected according to previously selected topics. Meaning, the occupant may select the topic selection made, and then the machine learning algorithm would update the preferred contexts automatically. After the topic is selected based on the context, the vehicle may provide an answer or indication to the occupant by operation of the vehicle or display of the answer. Indeed, an always listening algorithm may be used to identify topics requiring answer service and automatically provide an answer to the topic after invocation by a tag question phrase.

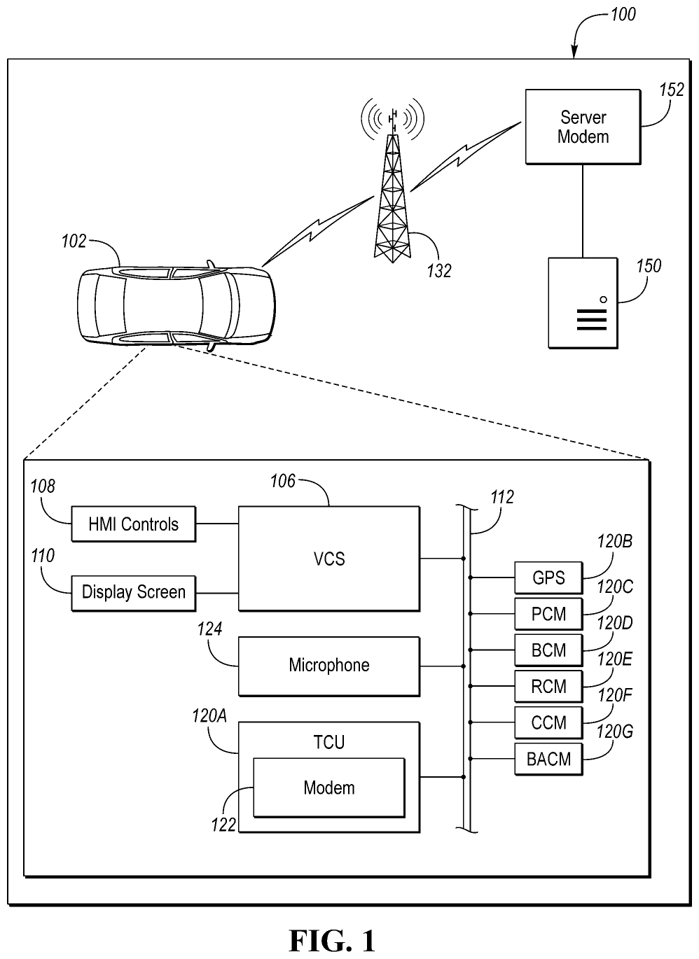

FIG. 1 illustrates an example system 100 including a vehicle 102 implementing an always listening answer retrieval algorithm. The vehicle 102 may include a vehicle computing system (VCS) 106 configured to communicate over a wide-area network using a telematics control unit (TCU) 120A. The TCU 120A may have various modems 122 configured to communicate over respective communications paths and protocols. While an example system 100 is shown in FIG. 1, the example components as illustrated are not intended to be limiting. Indeed, the system 100 may have more or fewer components, and additional or alternative components and/or implementations may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The VCS 106 may be configured to support voice command and BLUETOOTH interfaces with the driver and driver carry-on devices, receive user input via various buttons or other controls, and provide vehicle status information to a driver or other vehicle 102 occupant(s). An example VCS 106 may be the SYNC® system provided by FORD MOTOR COMPANY of Dearborn, Mich.

The VCS 106 may further include various types of computing apparatus in support of performance of the functions of the VCS 106 described herein. In an example, the VCS 106 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, a processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc.

The VCS 106 may be configured to communicate with TCU 120A. The TCU 120A may include a one or more modems 122 capable of packet-switch or circuit-switched signaling. The TCU 120A may control the operation of the modems 122 such that a suitable communication path is used. The modems may be configured to communicate over a variety of communications paths. The paths may be configured with circuit-switched 130, packet-switched 132, 134 signaling, or combination thereof. Packet-switched communication 132, 134 paths may be Internet Protocol (IP)-based or use packet-based switching to transfer information. For example, the packet-switched communication may be long-term evolution (LTE) communications. In some circumstances the circuit-switch 130 communication path may be SIGTRAN or another implementation, carrying circuit-switched signaling information over IP. The underlying signaling information is, however, still formatted under the circuit-switched protocol.

The VCS 106 may also receive input from human-machine interface (HMI) controls 108 configured to provide for occupant interaction with the vehicle 102. For instance, the VCS 106 may interface with one or more buttons or other HMI controls 108 configured to invoke functions on the VCS 106 (e.g., steering wheel audio buttons, a push-to-talk button, instrument panel controls, etc.). The VCS 106 may also drive or otherwise communicate with one or more displays 110 configured to provide visual output to vehicle occupants, e.g., by way of a video controller. In some cases, the display 110 may be a touch screen further configured to receive user touch input via the video controller, while in other cases the display 110 may be a display only, without touch input capabilities. In an example, the display 110 may be a head unit display included in a center console area of the vehicle 102 cabin. In another example, the display 110 may be a screen of a gauge cluster of the vehicle 102.

The VCS 106 may be further configured to communicate with other components of the vehicle 102 via one or more in-vehicle networks 112 or vehicle buses 112. The in-vehicle networks 112 may include one or more of a vehicle controller area network (CAN), an Ethernet network, and a media oriented system transfer (MOST), as some examples. The in-vehicle networks 112 may allow the VCS 106 to communicate with other vehicle 102 systems, such as a vehicle modem of the TCU 120A (which may not be present in some configurations), a global positioning system (GPS) module 120B configured to provide current vehicle 102 location and heading information, and various other vehicle ECUs configured to cooperate with the VCS 106. As some non-limiting possibilities, the vehicle ECUs may include a powertrain control module (PCM) 120C configured to provide control of engine operating components (e.g., idle control components, fuel delivery components, emissions control components, etc.) and monitoring of engine operating components (e.g., status of engine diagnostic codes); a body control module (BCM) 120D configured to manage various power control functions such as exterior lighting, interior lighting, keyless entry, remote start, and point of access status verification (e.g., closure status of the hood, doors and/or trunk of the vehicle 102); a radio transceiver module (RCM) 120E configured to communicate with key fobs or other local vehicle 102 devices; a climate control management (CCM) 120F module configured to provide control and monitoring of heating and cooling system components (e.g., compressor clutch and blower fan control, temperature sensor information, etc.); and a battery control module (BACM) 120G configured to monitor the state of charge or other parameters of the battery 104 of the vehicle 102.

In an example, the VCS 106 may be configured to access the communications features of the TCU 120A by communicating with the TCU 120A over a vehicle bus 112. As some examples, the vehicle bus 112 may include a controller area network (CAN) bus, an Ethernet bus, or a MOST bus. In other examples, the VCS 106 may communicate with the server 150 via a server modem 152 using the communications services of the modems 122.

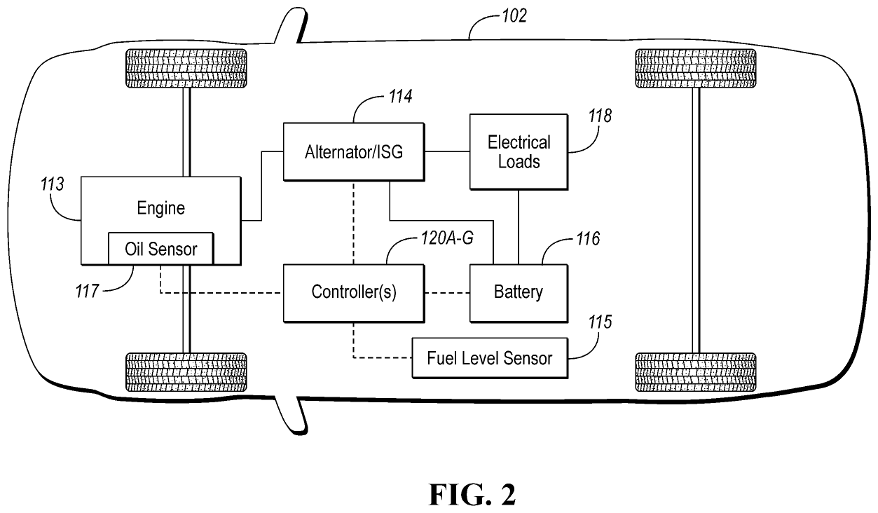

Referring to FIG. 2, the vehicle 102 may include an engine 113, starter-generator 114, battery 116, and electrical loads 118. The controller network 112 may connect to all of these vehicle systems through sensors (e.g., fuel level sensor 115, oil sensor 117) or vehicle system controllers (e.g., 120A, 120B, 120C, 120D, 120E, 120F, 120G). For example, the controller network 112 may control the vehicle systems to provide autonomous control. The engine 113 may have a direct mechanical linkage to the starter-generator 114. The starter-generator 114 may be electrically connected to the battery 116 and electrical loads 118. The battery 116 may be connected to the electrical loads 118. In response to overhearing the conversation mentioned above, the VCS 106 may recognize, as one non-limiting example, that the vehicle occupants desire to travel to Detroit if they have enough gas. The VCS 106 may pull data from vehicle sensors (i.e., fuel level sensor 115) to determine the remaining fuel in the fuel tank. The VCS 106 may then request the anticipated fuel consumption for the vehicle's 102 current location to the symphony orchestra. Indeed, the vehicle 102 can listen to the occupants' conversation and upon request provide a response without further requiring the question to be re-asked or the provision of additional information.

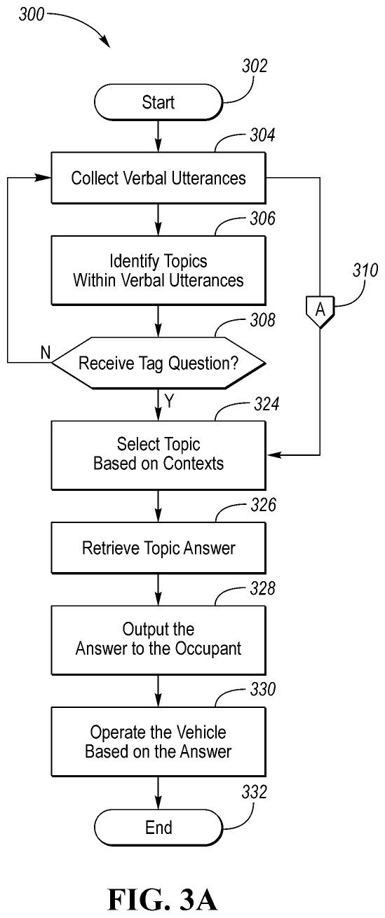

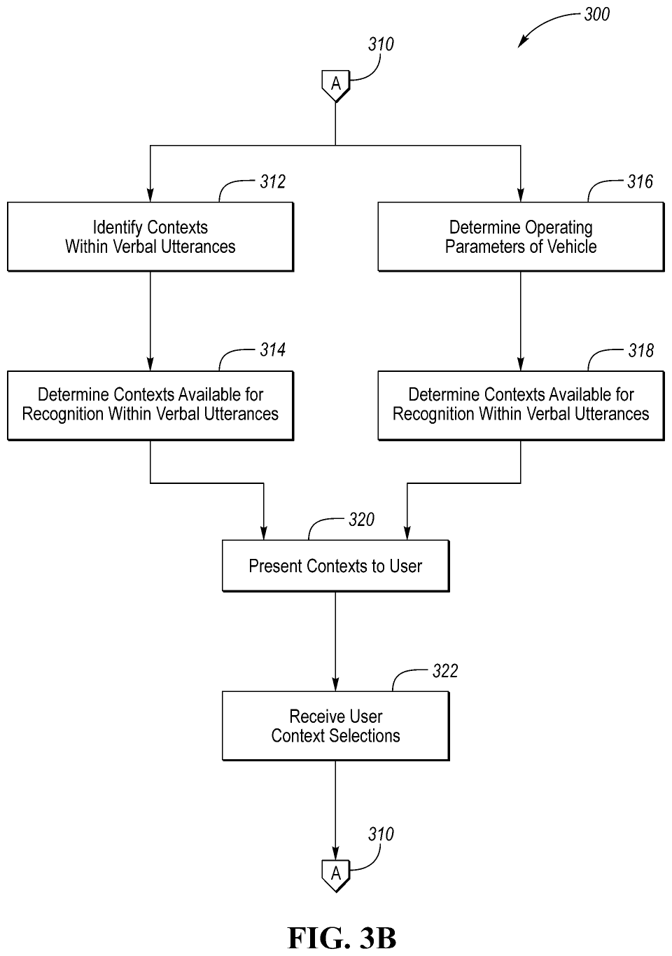

Referring to FIGS. 3A-B, an algorithm 300 is shown. The algorithm 300 starts in step 302. An implementation of the algorithm 300 may include additional or fewer steps, and the steps may be performed in a different order. The steps may also be performed simultaneously or at similar times. In step 304, the VCS 106 or other processors collect verbal utterances. The verbal utterances may be sayings, statements, uttered words, or conversations available for capture by the microphone or array of microphones 124. In step 306, topics are identified within the verbal utterances. The topics may be identified based on any natural language processing algorithm. Any part of speech may be used—or combination thereof—to determine the topics (e.g., nouns, verbs). The topics are identified to later be associated with the question asked. The topics may be portions of a sentence or entire sentences. The topics may be formed by verb-noun associations or other grammatical, syntactical, or semantical associations.

In step 308, a tag question is detected within the stream of verbal utterances. For example, the tag question may be “Ford®, what do you think?” The tag question phrase may include a moniker (e.g., Ford®). The moniker may also be self-named by the occupant or owner. The moniker may be a manufacturer or seller of the vehicle or VCS 106. The recognition of a tag question phrase invokes the question answering service.

After a tag question phrase is received in step 308, the algorithm will select an already-captured topic from the verbal utterances based on contexts, as defined in sub-algorithm A 310. Sub-algorithm A 310 collects information to define contexts. Contexts may be categories of topics or other logical representations configured to represent classes of vehicle operating parameters. As shown in step 312, sub-algorithm A 310 identifies contexts within verbal utterances. As one example, context identification may include nutrition information generally, while topic identification is more narrowly tuned to a question about nutrition in a candy bar. The list of contexts (e.g., nutrition, distance to destination, points of interest, weather) may be narrowly tuned for the vehicle in step 314 such that generic information requests are not available (e.g., answers to arithmetic, pronunciation of words). Meaning, broad question retrieval abilities may optionally be narrowed by the manufacturer or occupant under the assumption that vehicle or travel related questions will be present.

Similarly, in step 316, vehicle operating parameters are analyzed to provide contexts. For example, the vehicle 102 may be configured to make vehicle-specific parameter contexts available for the question-answer service. Meaning, contexts associated with oil life, fuel level, state of charge, climate status, engine temperature, or other vehicle parameters may be made available through contexts in step 316. A machine algorithm or manufacturer may select the operating parameters available for answer retrieval, in step 318. For example, oil temperature may be an available vehicle parameter, but a machine learning algorithm may determine that the context should not be made available because questions are so infrequently asked about engine oil temperature. Vehicle parameter contexts may be given a stronger weight that the verbal utterance contexts.

In step 320 the contexts are presented to the user. Meaning, the user can further select which contexts it may desire to have answered by the answer service. The contexts may be presented using the HMI controls 108 or the display screen 110. The contexts may be read by the system to the occupants and the occupants may provide confirmation of the proper context selection. For example, the vehicle may state, “Line 1: Weather.” The occupant may then verbally affirm that line one is the proper selection by saying, “One.” The contexts may be presented such that the most commonly used contexts are presented first. The contexts may also be presented in an order based on the verbal utterances already received and the frequency of the contexts being discussed. For example, if the weather in Detroit is a topic discussed along a road trip, the weather context may be presented to the user as a primary option. In step 322 the user context selections are received for use in step 324. The contexts may be assigned weights to improve the answer service. For example, the heavily discussed weather context may be given a stronger weight than the sparsely discussed oil temperature. All other things being equal, the heavier weighted context will take topic selection precedence over the unweighted or less-weighted context in the topic selection process of step 324.

In step 324, the selected contexts along with the identified topics are known. The algorithm may then recognize the topic to be determined based on the contexts. The topic selection may take into account the weights applied to the contexts that each topic resides in. For example, topics within the weather context may take precedence over the topics in the oil temperature context. Further, the topics syntactical and semantical strength may be weighted. For example, a confidence value of the topic may be determined based on the condition of the verbal utterance. Meaning, phrases that have grammatical coherence may fall within a stronger weighted context but be discounted because of the syntactical or semantical score. Additionally, proximity to the tag question phrase may be used to further weight the topic. For example, topics falling directly before the tag question phrase may have its score doubled or multiplied by a factor. Meaning, a context having a low weight may be selected over a context having a high weight if the topic immediately precedes the tag question phrase and the syntactical and semantical scores are low for the weather topic.

In step 326, the selected topic having the highest confidence score is sent to the server 150 to be answered. The server 150 provides the highest likely answer through the statistical and machine learning algorithms therein. Any answering service may provide the answer, and the answer does not need to be relative a vehicle. For example, the answer may be from an answering service such as Siri®, Google Now, or Cortana. The answer may be sent back to the vehicle 102 and presented to the occupants in step 328. In step 330, the vehicle 102 may then automatically operate the vehicle 102 based on the answer or prompt the user select a course of action. For example, if the topic selected was “I bet we have enough fuel to get to Detroit” the vehicle 102 may prepare a route to Detroit for the symphony and autonomously navigate the car to the destination.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. For example, an always listening algorithm may be used to identify topics requiring answer service and automatically provide an answer to the topic after invocation by a tag question phrase, which may not be based on an operating parameter of the vehicle. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
an interface; and
a controller configured to, responsive to input originating from verbal utterances of an occupant defining a plurality of different topics and ending with a question, select one of the topics for generating an answer to the question based on an operating parameter of the vehicle, and operate the interface to output the answer to the occupant.

2. The vehicle of claim 1, wherein a context of the operating parameter and a context of the verbal utterances are the same.

3. The vehicle of claim 2, wherein the operating parameter is a fuel level of the vehicle.

4. The vehicle of claim 2, wherein the controller is further configured to select the topic according to a confidence score of the topic based on syntactical, semantical, and grammatical scores.

5. The vehicle of claim 2, wherein controller is further configured to select the topic according to a confidence score of the topic based on a proximity of the topic to the question.

6. The vehicle of claim 1, wherein the controller is further configured to operate a vehicle control system based on the answer.

7. The vehicle of claim 1, wherein the question includes an interrogative where an object of the interrogative is a moniker.

8. The vehicle of claim 7, wherein the moniker is a manufacturer, make, or model of the vehicle.

9. The vehicle of claim 1, wherein the operating parameter is selected based on context selections associated with the occupant.

10. The vehicle of claim 1, wherein contexts are generated based on statements made while an answering algorithm is uninvoked.

11. The vehicle of claim 10, wherein the contexts are selected by a user.

12. The vehicle of claim 1, wherein the answer is retrieved when the topic is identified.

13. A method comprising:
by a controller,
selecting a topic for generating an answer to a question based on an operating parameter of a vehicle, responsive to input originating from verbal utterances of an occupant defining a plurality of different topics and ending with a question, and
operating an interface to output the answer to the occupant.

14. The method of claim 13, wherein a context of the operating parameter and a context of the verbal utterances are the same.

15. The method of claim 13, wherein the operating parameter is a fuel level of the vehicle.

16. The method of claim 13, wherein the topic is selected according to a confidence score of the topic based on syntactical, semantical, and grammatical scores.

17. The method of claim 13, wherein the topic is selected according to a confidence score of the topic based on a proximity of the topic to the question.

18. The method of claim 13 further comprising operating a vehicle control system based on the answer.

19. The method of claim 13, wherein the question includes an interrogative where an object of the interrogative is a moniker.

20. A vehicle comprising:
a controller configured to, responsive to receiving verbal utterances ending with a tag question phrase, isolate a topic from a set of topics within the verbal utterances based on an operating parameter of the vehicle, and operate the vehicle according to an answer to the topic provided by an answering algorithm.
